(19) United States
(12) Patent Application Publication
(10) Pub. No.: US 2022/0263177 A1
(43) Pub. Date: Aug. 18, 2022

(54) Systems and Methods of Battery Assembly with Interlocking Features

(71) Applicant: Atlis Motor Vehicles, Inc., Mesa, AZ (US)

(72) Inventors: Aniruddha Bhokarikar, Reno, NV (US); Huda Almashhadany, Mesa, AZ (US); Archit Deshpande, Mesa, AZ (US); Mark Hanchett, Mesa, AZ (US)

(73) Assignee: Atlis Motor Vehicles, Inc., Mesa, AZ (US)

(21) Appl. No.: 17/522,029

(22) Filed: Nov. 9, 2021

Related U.S. Application Data
(60) Provisional application No. 63/114,588, filed on Nov. 17, 2020.

(51) Int. Cl. H01M 50/244; H01M 50/204; H01M 50/262

(52) U.S. Cl. CPC H01M 50/244; H01M 50/262; H01M 50/204

(57) ABSTRACT

A battery pack includes an anode rail, a cathode rail and a plurality of battery cells. Each battery cell includes an anode terminal and a cathode terminal. The anode rail, cathode rail, anode terminal and cathode terminals include interlocking features. The battery pack is assembled by engaging the interlocking feature of the anode terminals with the interlocking feature of the anode rail and the interlocking feature of the cathode terminals with the interlocking feature of the cathode rail. The interlocking features may be keyed to ensure that anode and cathode terminals engage only with the anode rail in the cathode rail respectively.

### BACKGROUND

Embodiments of the present invention relate to battery cells and battery packs.

Battery cells include anode and cathode electrodes that connect to anode and cathode terminals respectively. A plurality of battery cells may be electrically coupled to each other to form a battery pack. The efficiency of manufacture and/or assembly of battery packs may be improved by using rails to connect to the terminals on the battery cells to form the battery pack. The manufacture and/or assembly of battery packs may further benefit from interlocking features on the rails and the terminals that engage each other to connect the battery cells to the rails.

### SUMMARY

A battery pack includes a two or more battery cells. Each battery cell has an anode terminal and a cathode terminal. The battery cells of the battery pack may be electrically connected to each other, in series and/or in parallel, using rails. Rails may be designated as anode rails for connecting to the anode terminals of the battery cells or cathode rails for connecting to the cathode terminals of the battery cells. The terminals and the rails may include interlocking features to mechanically couple the terminals to the rails. The interlocking feature of the terminal may engage the interlocking feature of the rail to mechanically couple the terminal to the rail. The anode terminals may include an interlocking feature that engages with the interlocking feature of an anode rail. The cathode terminals may include an interlocking feature that engages the interlocking feature of a cathode rail. The interlocking features of the anode terminals and rails and the cathode terminals and rails may be the same or different. In the case where the interlocking features for the anode terminals and rails are different from the interlocking features for the cathode terminals and rails, the anode terminals may engage only the anode rails and the cathode terminals may engage only the cathode rails thereby keying the battery cells for proper mechanical connection. Contact between a terminal and a rail further establishes an electrical connection between the terminal and the rail. The rails may be positioned with respect to each other so that coupling the terminals of the battery cells to the rails positions the battery cells with respect to each other.

Battery cells may include a container, anode electrodes, cathode electrodes, electrolytic chemicals, and anode terminal, and a cathode terminal. The anode terminal may be coupled to an anode end assembly. The cathode terminal may be coupled to a cathode end assembly. The anode end assembly may be coupled to one end of the container and the cathode end assembly to the other end of the container to retain the anode electrodes, cathode electrodes and electrolytic chemicals inside the container. The end assembly may include gaskets for insulating the terminal from the container. The anode electrodes coupled to the anode terminal and the cathode electrodes couple to the cathode terminal to permit the flow of electricity via the anode and cathode terminals during discharge and recharge.

The terminals may be implemented as a narrow terminal embodiment or a wide terminal embodiment. The wide terminal embodiment decreases electrical resistance (e.g., impedance) between the terminal and the electrodes connected to the terminal. The wide terminal embodiment also improves thermal transfer between the electrodes to the terminal.

### BRIEF DESCRIPTION OF THE DRAWING

Embodiments of the present invention will be described with reference to the drawing, wherein like designations denote like elements.

FIG. 1 is a diagram of a battery pack.

FIG. 2 is a cross-section of a narrow terminal embodiment of a battery cell of FIG. 1.

FIG. 3 is a diagram of an end assembly of the narrow terminal embodiment of FIG. 2.

FIG. 4 is a diagram of the rails of the battery pack and the positioning of battery cells by engaging interlocking features.

FIG. 5 is an example embodiment of the interlocking features of a terminal and a rail.

FIG. 6 is another example embodiment of the interlocking features of a terminal and a rail.

FIG. 7 is a cross-section of a wide terminal embodiment of a battery cell of FIG. 1.

FIG. 8 is a diagram of the container with respect to the wide terminal embodiment of FIG. 7.

### DETAILED DESCRIPTION

### Overview

Two or more battery cells (e.g., 110, 112, 114, 160) may be electrically coupled to each other to form the battery pack 100. The terminals (e.g., 120, 122, 124, 126, 130, 132) on the battery cells may include interlocking features (e.g., 160, 180, 560, 660) that engage with corresponding interlocking features (e.g., 162, 168, 580, 680) on the rails (e.g., 140, 142, 150, 152) of the battery pack 100 to mechanically and electrically couple the two or more battery cells to each other to form the battery pack 100.

A battery cell (e.g., 110, 112, 114, 160) includes a container (e.g., body, can) 170, anode electrodes 240, cathode electrodes 250, electrolytic chemicals (not shown), an anode terminal (e.g., 120, 122, 124, 126) and a cathode terminal (e.g., 130, 132). The anode electrodes, cathode electrodes and electrolytic chemicals are held (e.g., contained) in the container 170. The anode electrodes 240 mechanically and electrically coupled to the anode terminal (e.g., 120, 122, 124, 126). The cathode electrodes 250 mechanically and electrically couple to cathode terminal (e.g., 130, 132). The anode terminal and the cathode terminal are positioned, at least partially, on an outside of the container 170. In an example embodiment, the anode terminal (e.g., 120, 122, 124, 126), the cathode terminal (e.g., 130, 132), the anode rail (e.g., 140, 142) in the cathode rail (e.g., 130, 132) include interlocking features (e.g., 160, 162, 180, 182, 560, 580, 660, 680). The interlocking features (e.g., 160, 560, 580) of the anode terminal (e.g., 120, 122, 124, 126) and the interlocking features (e.g., 180, 560, 660) of the cathode terminal (e.g., 130, 132) engage with the interlocking features (e.g., 162, 580, 680) of the anode rail (e.g., 140, 142) and the cathode rail (e.g., 130, 132) respectively of the battery pack 100. Interlocking features may preclude mechanically and electrically coupling the anode terminal to the cathode rail and the cathode terminal to and the anode rail.

The terminals may be configured in various different embodiments. In an example embodiment, the terminals of the battery cell (e.g., 110, 112, 114, 116) use the narrow terminal embodiment. In the narrow terminal embodiment, the width of the terminal is not as wide as the terminal in the wide terminal embodiment. The wide terminal embodiment increases thermal transfer between the interior of the battery cell to the exterior of the battery cell via the terminal. The wide terminal embodiment further decreases the series resistance (e.g., impedance) of the electrodes mechanically and electrically coupled to the terminal.

The container 170 of the battery cell (e.g., 110, 112, 114, 116) may be assembled using end assemblies (e.g., 210, 220, 760, 770). An end assembly includes the terminal and structures for coupling to the ends of the container. The end assembly may include gaskets (e.g., 212, 214, 222, 226, 762, 772) for electrically insulating the end assembly and the terminal from the container 170.

### Battery Cell

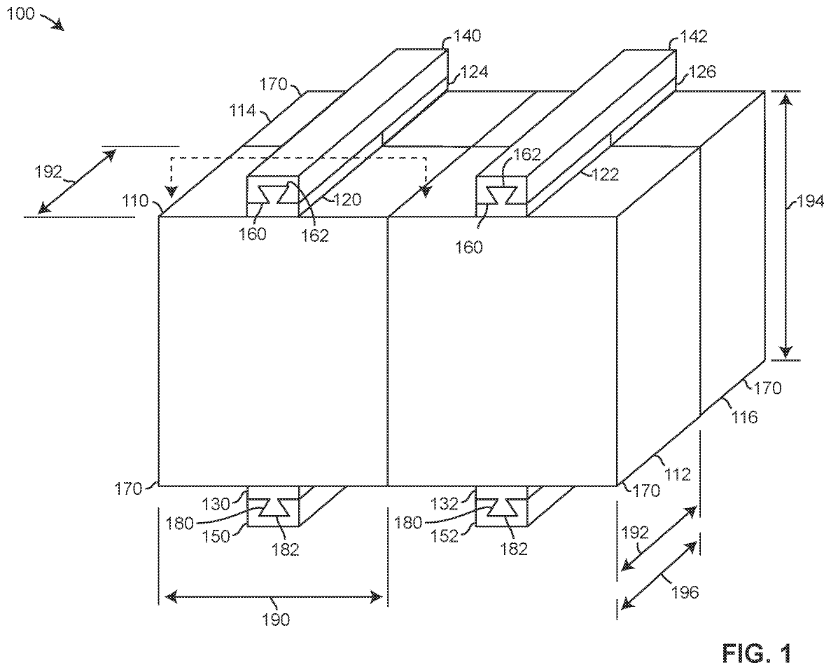

As best seen in FIGS. 1-5 and 7, a battery cell (e.g., 110, 112, 114, 116) includes a container 170, anode electrodes 240, cathode electrodes 250 and electrolytic chemicals (not shown to improve clarity). The electrolytic chemicals allow the battery cell 110 to provide a current while being discharged and to receive a current while being recharged. The container 170 has a width 190, a depth 192 and a height 194. The anode electrodes 240, the cathode electrodes 250 and the electrolytic chemicals are positioned inside the container 170. The anode terminal (e.g., 120, 122, 124, 126) and the cathode terminal (e.g., 130, 132) are positioned at least partially on the outside of the container 170. In an example embodiment, the anode terminal 120 is positioned on the top of the container 170 and cathode terminal 130 is positioned on the bottom of the container 170.

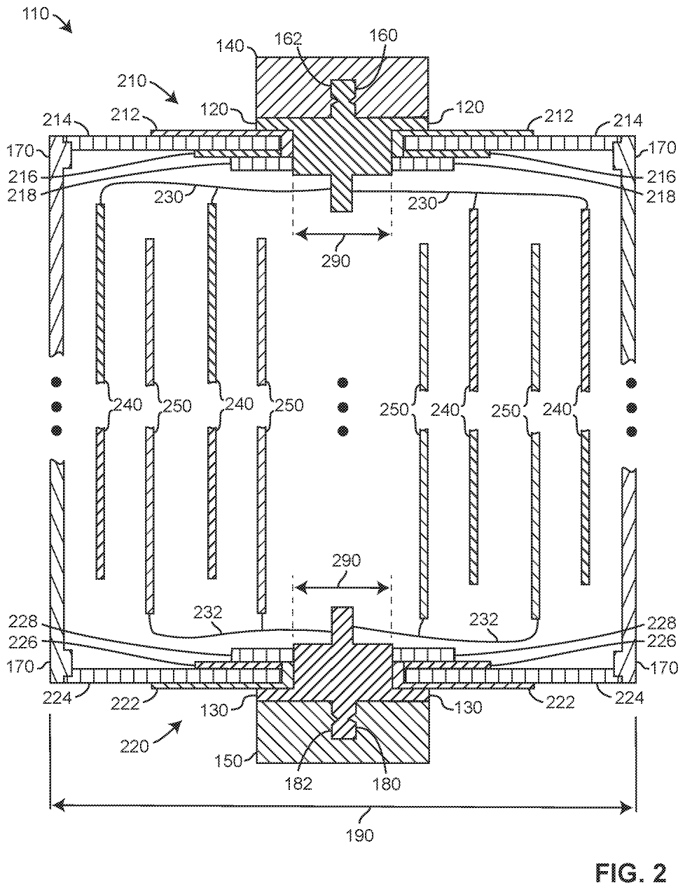

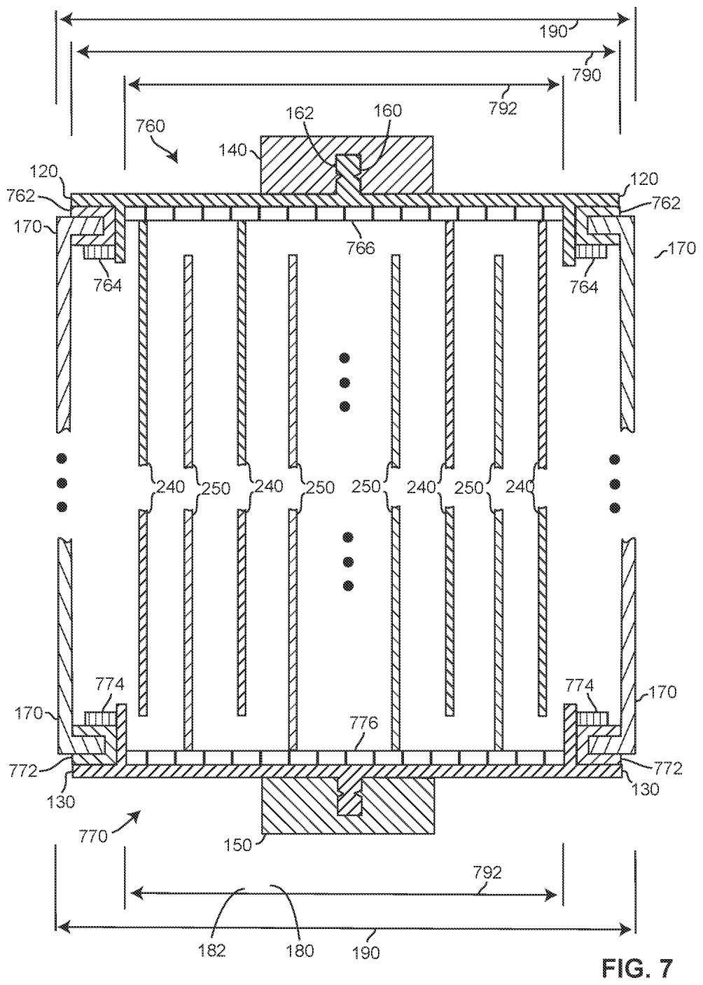

The anode terminal (e.g., 120, 122, 124, 126) and/or the cathode terminal (e.g., 130, 132) may be implemented as a wide terminal embodiment, as best seen in FIG. 7, or a narrow terminal embodiment, as best seen in FIG. 2. In the wide or narrow terminal embodiment, the length 196 of the anode terminal or the cathode terminal is about the same as the depth 192 of the container 170. In the narrow terminal embodiment, the width 290 of the anode terminal 120 and the cathode terminal 130 significantly less than the width 190 of the container 170. In the wide terminal embodiment, as best seen in FIG. 7, a width 790 of the anode terminal 120 and the cathode terminal 130 is almost as wide as the width 190 of the container 170.

Inside the container 170, the anode electrodes 240 mechanically and electrically coupled to the anode terminal, for example, the anode terminal 120 as shown. The cathode electrodes 250 mechanically and electrically coupled to the cathode terminal, for example, the cathode terminal 130 as shown. In the narrow terminal embodiment, some type of electrical connector (e.g., wire, conductor) connects most if not all of the anode electrodes 240 to the anode terminal 120. Further, some type of electrical connector connects most if not all of the cathode electrodes 250 to the cathode terminal 130. In the narrow terminal embodiment, few if any of the anode electrodes 240 and the cathode electrodes 250 connect directly to the anode terminal 120 or the cathode terminal 130 respectively. The electrical connector between the electrodes (e.g., 240, 250) and the terminals (e.g., 120, 130) introduces a resistance (e.g., impedance) between the electrode and the terminal. Further the electrical connector between the electrodes and the terminals may reduce thermal transfer capacity between the terminal and the electrodes, thereby reducing the thermal transfer capacity from the inside of the battery cell 110 to the outside of the battery cell 110 via the terminal (e.g., 120, 130).

In the wide terminal embodiment, all of the anode electrodes 240 and all of the cathode electrodes 250 connect directly to the anode terminal 120 or the cathode terminal 130 respectively. Connecting an electrode directly to its corresponded terminal reduces the resistance between the electrode and the terminal. Further, directly connecting the electrode to the terminal along the entire length of the terminal increases the thermal transfer capacity of the electrode and the terminal, thereby increasing heat transfer into and out of the battery cell 110.

A terminal (e.g., 120, 122, 124, 126, 130, 132) also facilitates mechanically and electrically coupling two or more battery cells together to form a battery pack 100. The terminals may mechanically and electrically couple to rails to form the battery pack 100. The interlocking features of the terminals and the rails facilitate mechanical and electrical coupling of the battery cells to each other to form the battery pack 100. Engaging the interlocking feature 160 of the anode terminal 120, 122, 124 and 126 to the interlocking feature 162 of the anode rail 140 or 142 couples the anode terminal 120, 122, 124 and 126 to the anode rail 140 or 142. Engaging the interlocking feature 180 of the cathode terminal 130 and 132 to the interlocking feature 182 of the cathode rail 150 or 152 couples the cathode terminal 130 and 132 to the cathode rail 150 or 152. The battery cell 114 and 116 include cathode terminals that connect to cathode rails 150 and 152 respectively, but the cathode terminals for the battery cell 114 and 116 are not shown in the drawing.

In an example embodiment, the battery cell 110 includes a plurality of anode electrodes 240, a plurality of cathode electrodes 250, the container 170, the anode terminal 120 and the cathode terminal 130. The container has the width 190 (e.g., first width). The plurality of the anode electrodes 240 and the plurality of cathode electrodes 250 are positioned inside the container 170. Each anode electrode 240 of the plurality of anode electrodes mechanically and electrically couples to the anode terminal 120. Each cathode electrode 250 of the plurality of cathode electrodes mechanically and electrically couples to the cathode terminal 130.

The anode terminal 120 has a width 290 (e.g., second width). The cathode terminal 130 has a width 290 (e.g., third width). The anode terminal 120 is positioned at least partially on the exterior of the container 170. The cathode terminal 130 is positioned to least partially on the exterior of the container 170. The anode terminal 120 includes an interlocking feature 160 (e.g., first interlocking feature) adapted to engage with an interlocking feature 162 (e.g., second interlocking feature) of an anode rail 140 of the battery pack 100. The cathode terminal 130 includes an interlocking feature 180 (e.g., third interlocking feature) adapted to engage with an interlocking feature 182 (e.g., fourth interlocking feature) of a cathode rail 150 of the battery pack 100.

### Interlocking Feature Embodiments

Interlocking features, as best seen in FIGS. 1-2 and 4-7, may be used to mechanically and electrically couple the terminals (e.g., 120, 122, 124, 126, 130, 132) of a plurality of battery cells (e.g., 110, 112, 114, 116) to the rails (e.g., 140, 142, 150, 152) of the battery pack 100. The rails of the battery pack 100 may be positioned relative to each other to position the battery cells (e.g., 110, 112, 114, 116) with respect to each other.

In an embodiment, the interlocking feature (e.g., 160, 180) of the terminal (e.g., 120, 122, 124, 126, 130, 132) slidingly engages the interlocking feature (e.g., 162, 182) of the rail (e.g., 140, 142, 150, 152). In an example embodiment, the interlocking feature (e.g., 160, 180) of the terminal (e.g., 120, 122, 124, 126, 130, 132) engages (e.g., mates, interlaces) with the interlocking feature (e.g., 162, 182) of the rail (e.g., 140, 142, 150, 152) slidingly along a length of the rail. Even though the terminal may move along the length of the rail while the interlocking feature (e.g., 160, 180) of the terminal (e.g., 120, 122, 124, 126, 130, 132) is engaged with the interlocking feature (e.g., 162, 182) of the rail (e.g., 140, 142, 150, 152), the interlocking feature of the terminal interferes with (e.g., is obstructed by, is constrained by) the interlocking feature of the rail to mechanically couple the terminal, and thereby the battery cell, to the rail. For example, even though the terminal may move along the length of the rail, the interlocking features constrain the terminal from moving in any other direction other than along the length of the rail.

Additional structure (e.g., screw, clamp) may be used to stop the terminal from sliding along the rail thereby completely constraining movement of the terminal, and thus the battery cell, with respect to the rail.

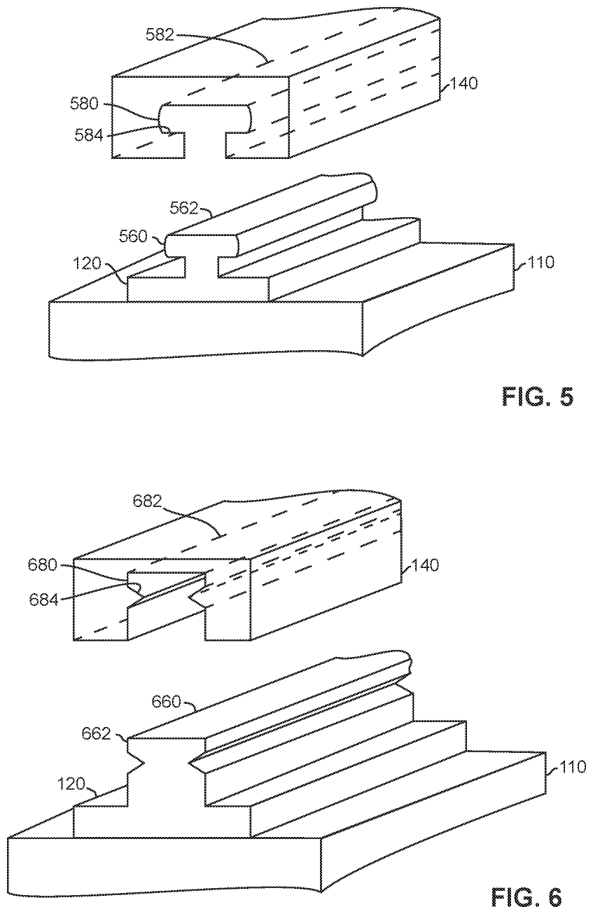

In a first example embodiment of interlocking features, referring to FIG. 5, the anode rail 140 includes interlocking feature 580 and anode terminal 120 includes the interlocking feature 560. The interlocking feature 580 includes a groove 582 along the length of the anode rail 140. A protrusion 562 of interlocking feature 560 is inserted into the groove 582. The protrusion 562 may slide along the length of the groove 582. However, an inner surface 584 of the groove 582 interferes with (e.g., obstructs) the vertical movement of the protrusion 562 thereby mechanically coupling the interlocking feature 560 to the interlocking feature 580 and thereby the anode terminal 120 to the anode rail 140. Physical contact between the interlocking feature 560, the interlocking feature 580, the anode rail 140 and/or the anode terminal 120 further establishes electrical contact between the anode rail 140 and the anode terminal 120. The anode rail 140 and the anode terminal 120 may be formed of a conductive material, such as a metal (e.g., aluminum, copper, steel).

All anode terminals (e.g., 120, 122, 124, 126) and all cathode terminals (e.g., 130, 132) may include the first example embodiment of the interlocking feature 560. All anode rails (e.g., 140, 142) and all cathode rails (e.g., 150, 152) may include the first example embodiment of the interlocking feature 580.

In a second example embodiment of interlocking features, referring to FIG. 6, the anode rail 140 includes interlocking feature 680 and anode terminal 120 includes the interlocking feature 660. The interlocking feature 680 includes a groove 682 along the length of the anode rail 140. A protrusion 662 of interlocking feature 660 is inserted into the groove 682. The protrusion 662 may slide along the length of the groove 682. However, a surface 684 of the groove 682 interferes with (e.g., obstructs) the vertical movement of the protrusion 662 thereby mechanically coupling the interlocking feature 660 to the interlocking feature 580 and thereby the anode terminal 120 to the anode rail 140. Physical contact between the interlocking feature 660, the interlocking feature 680, the anode rail 140 and/or the anode terminal 120 further establishes electrical contact between the anode rail 140 and the anode terminal 120. The anode rail 140 and the anode terminal 120 may be formed of a conductive material, such as a metal.

In an example embodiment, all anode terminals (e.g., 120, 122, 124, 126) and all cathode terminals (e.g., 130, 132) include the second example embodiment of the interlocking feature 660. All anode rails (e.g., 140, 142) and all cathode rails (e.g., 150, 152) include the second example embodiment of the interlocking feature 680.

In another example embodiment, all anode terminals (e.g., 120, 122, 124, 126) and all anode rails (e.g., 140, 142) include the first example embodiment of the interlocking feature 560 and interlocking feature 580 respectively. All cathode terminals (e.g., 130, 132) and all cathode rails (e.g., 150, 152) include the second example embodiment of the interlocking feature 660 and interlocking feature 680 respectively. Because the interlocking feature 560 of the anode terminals (e.g., 120, 122, 124, 126) is not compatible (e.g., cannot be engaged) with the interlocking feature 680 of the cathode rails (e.g., 150, 152) and the interlocking feature 660 of the cathode terminals (e.g., 130, 132) is not compatible with the interlocking feature 580 of the anode rails (e.g., 140, 142), the anode terminals cannot be inadvertently coupled to the cathode rails and the cathode terminals cannot be inadvertently coupled to the anode rails. Using different embodiment of interlocking features for anode terminals and rails as opposed to the interlocking features for cathode terminals and rails decreases the likelihood of connection errors while assembling the battery pack 100.

A third example embodiment of interlocking features is shown in FIG. 1. The interlocking features of FIG. 1 are similar to a dove tail joint.

In an example embodiment, a battery pack 100 includes an anode rail (e.g., 140, 142), a cathode rail (e.g., 150, 152) and a plurality of battery cells (e.g., 110, 112, 114, 116). Each battery cell of the plurality includes an anode terminal (e.g., 120) and a cathode terminal (e.g., 130). Each anode terminal includes a first interlocking feature (e.g., 160, 560, 660) and each cathode terminal includes a second interlocking feature (e.g., 180, 560, 660). The anode rail includes a third interlocking feature (e.g., 162, 580, 680) adapted to engage with the first interlocking feature of each anode terminal. The cathode rail includes a fourth interlocking feature (e.g., 182, 580, 680) adapted to engage with the second interlocking feature of each cathode terminal.

In an example embodiment, the first interlocking feature (e.g., anode terminal) is adapted to not engage with the fourth interlocking feature (e.g., cathode rail). The second interlocking feature (e.g., cathode terminal) is adapted to not engage with the third interlocking feature e.g., anode rail), whereby the anode terminal cannot engage the cathode rail and the cathode terminal cannot engage the anode rail.

In an example embodiment, the first interlocking feature (e.g., anode terminal) and the second interlocking feature (e.g., cathode terminal) slidingly engage the third interlocking feature (e.g., anode rail) and the fourth interlocking feature (e.g., cathode rail) respectively to mechanically and electrically couple the anode terminal to the anode rail and the cathode terminal to the cathode rail respectively.

In an example embodiment, the first interlocking feature (e.g., anode terminal) and the second interlocking feature (e.g., cathode terminal) are adapted to mechanically interfere with the third interlocking feature (e.g., anode rail) and the fourth interlocking feature (e.g., cathode rail) respectively to maintain mechanical and electrical coupling of the anode terminal and the cathode terminal with the anode rail and the cathode rail respectively.

In an example embodiment, the first interlocking feature (e.g., anode terminal) comprises a protrusion. The second interlocking feature (e.g., cathode terminal) comprises a groove. The protrusion slidably engages the groove. An inner surface of the groove interferes with an outer surface of the protrusion to maintain engagement of the protrusion with the groove.

In another example embodiment, the first interlocking feature (e.g., anode terminal) comprises a groove. The second interlocking feature (e.g., cathode terminal) comprises a protrusion. The protrusion slidably engages the groove. An inner surface of the groove interferes with an outer surface of the protrusion to maintain engagement of the protrusion with the groove.

### Wide and Narrow Terminal Width

Two embodiments of terminals (e.g., anode, cathode) are discussed above. One embodiment is described as having a wide terminal width, while the other embodiment is identified as having a narrow terminal width. The width of the terminal (e.g., 120, 122, 124, 126, 130, 132) may be described with respect to the width 190 of the container 170. As best seen in FIGS. 1-3 and 7, the container 170 of battery cell 110 has the width 190, the depth 192 and the height 194. The anode terminal 120, or any anode terminal (e.g., 122, 124, 126) or cathode terminal (e.g., 130, 132), has the width 290, in the narrow terminal embodiment as shown in FIG. 2, or the width 790, in the wide terminal embodiment as shown in FIG. 7.

In the narrow terminal embodiment, the width 290 of the anode terminal 120 or cathode terminal 130 is between 18 and 40 percent, preferably 20 percent, of the width 190 of the container 170. In an example embodiment, the width 290 of the anode terminal 120 and/or the cathode terminal 130 is at most 30 percent of the width 190. The length of the anode terminal 120 and/or the cathode terminal 130 is length 196. The area of the anode terminal 120 available for connecting to anode electrodes is the length 196 times the width 290. Because the width 290 of the anode terminal 120 or cathode terminal 130 is less than the width 190 of the container 170, a conductor 230 extends from the anode terminal 120 to each anode electrode 240 to connect the anode electrodes 240 to the anode terminal 120. A conductor 232 extends from the cathode terminal 130 to each cathode electrode 250 to connect the cathode electrodes 250 to the cathode terminal 130. The conductors 230 and 232 may increase the impedance between the anode terminal 120 and the cathode terminal 130 and the anode electrodes 240 and the cathode electrodes 250 respectively. The conductors 230 and 232 may reduce thermal conductivity between the anode electrodes 240 and the cathode electrodes 250 and the anode terminal 120 and the cathode terminal 130 respectively.

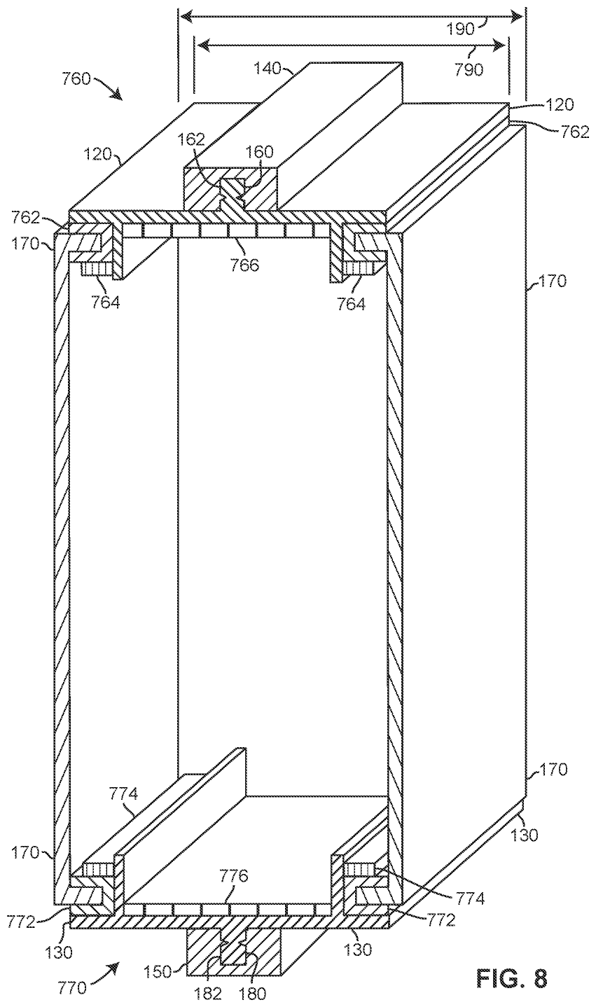

In the wide terminal embodiment, referring to FIGS. 7 and 8, the width 790 of the anode terminal 120 or cathode terminal 130 is between 70 and 96 percent, preferably at least 90 percent, of the width 190 of the container 170. In an example embodiment, the width 790 of the anode terminal 120 and/or the cathode terminal 130 is at least 80 percent of the width 190. In an example embodiment, the anode electrodes 240 chemically and electrically couple to the plate 766, which mechanically and electrically couples to the anode terminal 120. The cathode electrodes 250 mechanically and electrically couple to a plate 776, which mechanically and electrically couples to the cathode terminal 130. So, the anode electrodes 240 and the cathode electrodes 250 mechanically and electrically coupled to the anode terminal 120 and the cathode terminal 130 through (e.g., via) the plate 776 and the plate 776.

The width of the plate 766 or 776 is width 792. The length of the plate 766 or 776 is length 196. The area of the wide terminal embodiment available for connecting to electrodes is significantly greater than the area of the narrow terminal embodiment. The wider width of the width 790 makes it possible to mechanically and electrically couple all of the anode electrodes 240 and all of the cathode electrodes 250 to the anode terminal 120 and the cathode terminal 130 without use of an additional conductor, such as the conductor 230 or 232. The wider width 790 decreases the resistance between the terminal (e.g., 120, 130) and the electrodes (e.g., 2040, 250) connected to the terminal. Further, because the area of the electrode that connects to the wider terminal increases, the thermal transfer of heat between the electrodes and the terminal is increased. The electrodes may be connected to the plate 766 or 776 anywhere along the length 196 of the plate thereby reducing impedance between the electrode and the terminal and also increasing thermal conductivity between the electrode and the terminal.

In an example embodiment of a wide terminal, the battery cell 110 includes a plurality of anode electrodes 240, a plurality of cathode electrodes 250, a container 170, and anode terminal 120 and a cathode terminal 130. The width of the container 170 is the width 190 (e.g., a first width). The length of the container 170 is the depth 192 (e.g., a first length). The plurality of anode electrode 240 and the plurality of cathode electrodes 250 are positioned in the container 170.

The width of the anode terminal 120 is a second width (e.g., width 790). The length of the anode terminal 120 is a second length (e.g., length 196). The second width and the second length are at least 90% of the first width and the first length respectively. The anode terminal 120 is positioned at least partially on an exterior of the container 170. Each anode electrode 240 of the plurality of anode electrodes mechanically and electrically couples to the anode terminal 120. Each anode electrode 240 may connect to the anode terminal 120 anywhere along the length 196 of the anode electrode 240 and the anode terminal 120. The anode terminal 120 includes a first interlocking feature (e.g., 160, 560, 660) adapted to slidingly engage with a second interlocking feature (e.g., 162, 580, 680) of an anode rail 140 of the battery pack 100 to mechanically and electrically couple the anode terminal 120 to the anode rail 140.

The width of the cathode terminal 130 is a third width (e.g., width 790). The length of the cathode terminal 130 is a third length (e.g., length 196). The third width and the third length are at least 90% of the first width and the first length respectively. The cathode terminal 130 is positioned at least partially on an exterior of the container 170. Each cathode electrode 250 of the plurality of cathode electrodes mechanically and electrically couples to the cathode terminal 130. Each cathode electrode 250 may connect to the cathode terminal 130 along the any location along the length 196 of the cathode electrode 250 and the cathode terminal 130. The cathode terminal 130 includes a first interlocking feature (e.g., 180, 560, 660) adapted to slidingly engage with a fourth interlocking feature (e.g., 182, 580, 680) of a cathode rail 150 of the battery pack 100 to mechanically and electrically couple the cathode terminal 130 to the cathode rail 150.

The battery cell 110 of the present example embodiment further includes a gasket 762 positioned around the anode terminal 120. The gasket 762 electrically insulate the container 170 from the anode terminal 120. The battery cell 110 further includes a steel ring 764 positioned around the anode terminal 120 and against the gasket 762. The steel ring 764 retains the gasket 762 in position around the anode terminal 120. The cathode terminal 130 includes similar structure. For example, the battery cell 110 further includes a gasket 772 and a steel ring 774. The gasket 772 electrically insulate the container 170 from the cathode terminal 130. The steel ring 774 positioned around the cathode terminal 130 and against the gasket 772. The steel ring 774 retains the gasket 772 in position around the cathode terminal 130. One end (e.g., top) of the container 170 couples to the gasket 762. The other end (e.g., bottom) of the container 170 couples to the gasket 772. The gaskets 762 and 772 and the steel rings 764 and 774 hold the ends of the container 170 in place thereby forming the container 170.

### Battery Pack

As discussed above, two or more battery cells (e.g., 110, 112, 114, 116) may be electrically coupled together to form the battery pack 100. The coupling between the battery cells may be in serial and/or parallel. As further discussed above, rails (e.g., 140, 142, 150, 152) may be used to establish electrical connections between battery cells. The rails may further be used to physically position battery cells with respect to each other. The rails may be positioned relative to each other. The rails may be in a fixed position relative to each other. Placing the rails in a fixed position relative to each other positions the battery cells with respect to the rails and with respect to each other when the battery cells are connected to the rails.

As discussed above, the terminals (e.g., anode, cathode) of the battery cells and the rails may include interlocking features. The interlocking features of the terminals engage with the interlocking features of the rails to mechanically and electrically couple the battery cells to the rails. The current delivered to and from the battery pack 100 flows via the rails and the terminals. As further discussed above, the interlocking features of the terminals may slidably engage with the interlocking features of the rails. A terminal may slide along a length of a rail to be positioned. The interlocking features further interfere with each other to stop vertical movement of the battery cells. A block (e.g., stop, wedge) may be used to fix the position of a battery cell along the length of a rail thereby fixing the position of the battery cell with respect to the rail and the other battery cells of the battery pack 100. For example, a block 410 is positioned over the end of the anode rail 140. The block 410 stops the movement of the anode terminal 122 along the length of the anode rail 140 at least in one direction. Once the terminals of the battery cells are interlocked onto the rails, the block 410 may be connected to both ends of the rails to fully connect the battery cells to the rails.

In an example embodiment, the battery pack 100 includes a plurality of battery cells (e.g., 110, 112, 114, 116), an anode rail (e.g., 140, 142) and a cathode rail (e.g., 150, 152). Each battery cell includes an anode terminal (e.g., 120, 122, 124, 126), a cathode terminal (e.g., 130, 132) and a container (e.g., 170, 172, 174, 176). The container has the width 190 (e.g., first width). The anode terminal and the cathode terminal positioned to least partially on an outer surface of the container. Each anode terminal includes an interlocking feature (e.g., 160, 560, 660, first interlocking feature). Each cathode terminal includes an interlocking feature (e.g., 180, 560, 660, second interlocking feature). The anode rail includes an interlocking feature (e.g., 162, 580, 680, third interlocking feature) adapted to engage with the first interlocking feature of each anode terminal. The cathode rail includes an interlocking feature (e.g., 182, 580, 680, fourth interlocking feature), adapted to engage with the second interlocking feature of each cathode terminal.

While engaged, the first interlocking feature (e.g., 160, 560, 660) of each anode terminal (e.g., 120, 122, 124, 126) interferes with the third interlocking feature (e.g., 162, 580, 680) of the anode rail thereby mechanically coupling the anode terminal to the anode rail (e.g., 140, 142). While engaged, the second interlocking feature (e.g., 180, 560, 660) of each cathode terminal (e.g., 130, 132) interferes with the fourth interlocking feature (e.g., 182, 580, 680) of the cathode rail (e.g., 150, 152) thereby mechanically coupling the cathode terminal to the cathode rail. While the first interlocking feature of each anode terminal is engaged with the third interlocking feature of the anode rail, the anode terminal electrically couples to the anode rail. While the second interlocking feature of each cathode terminal is engaged with the fourth interlocking feature of the cathode rail, the cathode terminal electrically couples to the cathode rail.

Engaging the first interlocking feature of each anode terminal to the third interlocking feature of the anode rail and the second interlocking feature of each cathode terminal to the fourth interlocking feature of the cathode rail physically positions the plurality of battery cells with respect to each other.

### Example Implementations of Battery Cell

The structure of a battery cell may include a container 170 (e.g., can, body), a first end assembly 210 (e.g., cap, lid, cover), and a second end assembly 220. The container 170 forms a cavity for placement of the electrodes (e.g., anode, cathode) and electrolyte (e.g., collectively a jelly roll).

In an example embodiment, the shape of the container 170 is a rectangular prism. In this embodiment, the container 170 includes four sides with two opposing open ends. The first end assembly 210 may couple to a first open end of the container 170 to close the first end. The first end assembly 210 may seal the first open end of the container 170. The second end assembly 220 may couple to the second open end of the container 170 to close the second end. The second end assembly 220 may seal the second open end of the container 170.

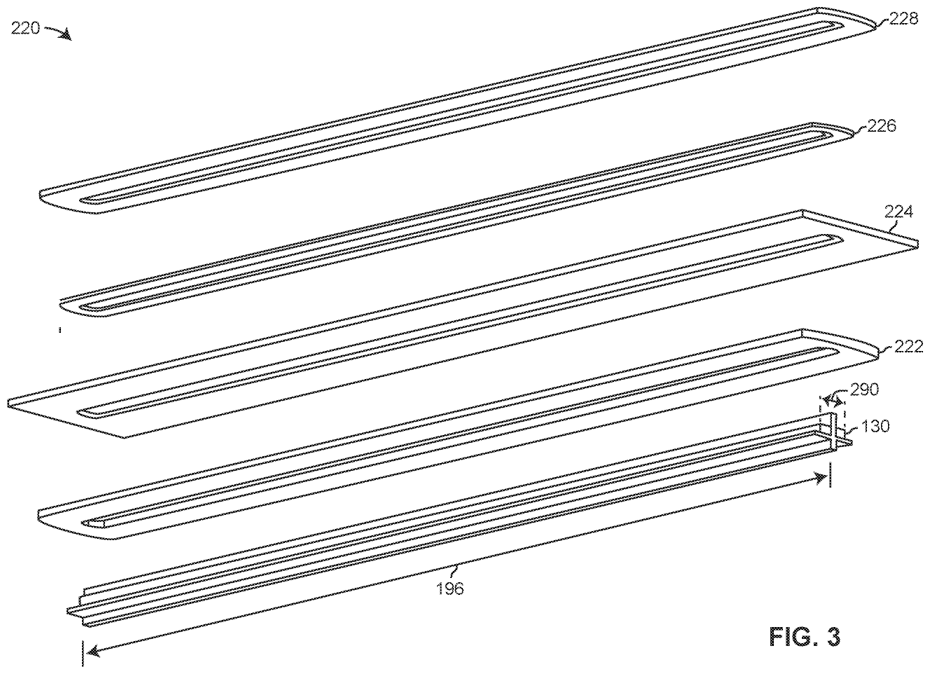

In an example embodiment, as best shown in FIGS. 2-3, the end assembly includes a terminal. The terminal at one end of the container 170 is the anode terminal 120 while the terminal at the other end of the container 170 is a cathode terminal 130. The anode terminal 120 and the cathode terminal 130 couple to the anode electrode 240 and the cathode electrodes 250 respectively positioned inside the container 170. The end assembly 210 and 220 couple to the container 170 in any manner (e.g., welding, press-fit, glue). The terminal (e.g., 120, 130) of an end assembly couples to the corresponding electrodes (e.g., 240, 250) in any manner (e.g., welding, press-fit, interference). In an example implementation, the end assembly (e.g., 210, 220) electrically insulates the terminal (e.g., 120, 130) from the container 170 so the anode electrodes 240 and the anode terminal 120 does not electrically couple to each other (e.g., short out).

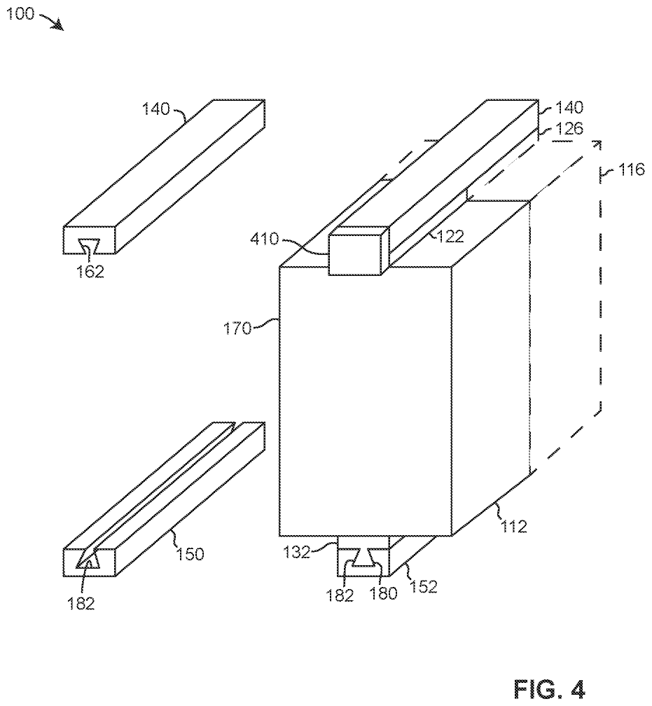

In an example embodiment, referring to FIGS. 2-3, the battery cell 110 includes the container 170, the anode end assembly 210, and the cathode end assembly 220. In FIG. 4, the interlocking feature 160 of anode terminal 120 and the interlocking feature 180 of the cathode terminal 130 respectively are shown inserted into the interlocking feature 162 of the anode rail 140 and the interlocking feature 182 of the cathode rail 150 respectively. The electrolyte of the battery cell 110 is not shown in FIG. 2.

The end assembly 210 includes the plastic gasket 212, the steel plate 214, the plastic gasket 216, and the steel washer 218. The end assembly 220 includes the plastic gasket 222, the steel plate 224, the plastic gasket 226, and the steel washer 228.

In an example embodiment, the end assembly 210 is assembled by placing the plastic gasket 216 between the steel washer 218 and the steel plate 214 and the plastic gasket 212 between the steel plate and the anode terminal 120. The relative positions and shapes of the anode terminal 120, the plastic gasket 212, the steel plate 214, the plastic gasket 216, and the steel washer 218 are shown in FIG. 3. The implementation shown in FIGS. 2-3 is a narrow terminal embodiment. After aligning the parts of the end assembly 210, the parts (e.g., 120, 212, 214, 216, 218) are pressed together so that a portion of the anode terminal 120 enters into an opening of the steel washer 218. The size of the opening of the steel washer 218 into which the portion of the anode terminal 120 enters is sized so that the contact between the steel washer 218 and the anode terminal 120 deforms the sides of the steel washer 218 and/or the anode terminal 120 to mechanically couple the steel washer 218 to the anode terminal 120. As can be seen in FIG. 4, the plastic gasket 212 and the plastic gasket 216 cooperate to insulate the steel washer 218 and the anode terminal 120 from the steel plate 214. The plastic gasket 212 and the plastic gasket 216 are formed of an insulating material to electrically insulate the steel plate 214 from the steel washer 218 and the anode terminal 120, thereby insulating the anode electrodes 240 that are coupled to the anode terminal 120 from the steel plate 214. Insulating the anode terminal 120 and the steel washer 218 from the steel plate 214 electrically insulates the anode terminal 120 from the container 170. One end of the container 170 couples to the steel plate 214.

The end assembly 220 may be assembled in the same manner as the end assembly 210. The plastic gasket 222 and the plastic gasket 226 cooperate to insulate the steel washer 228 and the cathode terminal 130 from steel plate 224 in the same manner as described above. As discussed above, the plastic gasket 222 and the plastic gasket 226 insulate the cathode terminal 130 from the container 170. One other of the container 170 couples to the steel plate 224 to fully enclose the container 170.

The anode end assembly 210 and the cathode end assembly 220 may be positioned in (e.g., over) the respective openings of the container 170 and coupled to the container 170 to form and enclose the container 170 of battery cell 110. The anode end assembly 210 and the cathode end assembly 220 couple to the container 170 in any conventional manner (e.g., press fit, welding, glue). The battery cell 110, after it has been assembled, may be mechanically and electrically coupled to the anode rail 140 and the cathode rail 150 using interlocking features 160, 162, 180 and 182 as shown in FIGS. 1-2 and as discussed above.

In another example embodiment of the wide terminal embodiment, the battery cell 110 includes an anode end assembly 760, a cathode end assembly 770 and the container 170. The anode end assembly 760 includes the anode terminal 120 (e.g., the wide terminal embodiment), a gasket 762, a steel ring 764 and a plate 766. The cathode end assembly 770 includes the cathode terminal 130 (e.g., the wide terminal embodiment), a gasket 772, a steel ring 774, and a plate 776.

To assemble the anode end assembly 760, the plate 766 is connected to the anode terminal 120. The plate 766 is conductive and may be connected to the anode terminal, which is also conductive, in any conventional manner to maintain conductivity and coupling. The gasket 762 is placed around the anode terminal 120. The steel ring 764 is pressed around the anode terminal 120 and against the gasket 762 to hold the gasket 762 in place. The steel ring 764 may be held in place by a press fit connection with the anode terminal 120. The cathode end assembly 770 may be assembled in the same way that the anode end assembly 760 is assembled.

One end (e.g., top) of the container 170 is connected to the anode end assembly 760 by pressing the end of the container 170 into the gasket 762. The gasket 762 mechanically couples to the end of the container 170 to hold the end of the container in place. The gasket 762 is not conductive, so the container 170 is insulated from the anode terminal 120. The other end (e.g., bottom) of the container 170 is connected to the cathode end assembly 770 by pressing the end of the container 170 into the gasket 772. The gasket 772 mechanically couples to the end of the container 170 to hold the end of the container 170 in place. The gasket 772 is not conductive, so the container 170 is insulated from the cathode terminal 130.

### Afterword

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A battery cell comprising:
a plurality of anode electrodes;
a plurality of cathode electrodes;
a container having a first width, the plurality of anode electrodes and the plurality of cathode electrodes positioned in the container;
an anode terminal having a second width, the anode terminal positioned at least partially on an exterior of the container, each anode electrode of the plurality of anode electrodes mechanically and electrically couples to the anode terminal, the anode terminal includes a first interlocking feature adapted to engage with a second interlocking feature of an anode rail of a battery pack; and
a cathode terminal having a third width, the cathode terminal positioned at least partially on the exterior of the container, each cathode electrode of the plurality of cathode electrodes mechanically and electrically couples to the cathode terminal, the cathode terminal includes a third interlocking feature adapted to engage with a fourth interlocking feature of a cathode rail of the battery pack.

2. The battery cell of claim 1 wherein at least one of the second width in the third width is at least 70 percent of the first width.

3. The battery cell of claim 1 wherein at least one of the second width and the third width is at most 30 percent of the first width.

4. The battery cell of claim 1 wherein:
the first interlocking feature is adapted to not engage with the fourth interlocking feature; and
the third interlocking feature is adapted to not engage with the second interlocking feature, whereby the anode terminal cannot engage the cathode rail and the cathode terminal cannot engage the anode rail.

5. The battery cell of claim 1 wherein the first interlocking feature and the third interlocking feature slidingly engage the second interlocking feature and the fourth interlocking feature respectively to mechanically and electrically couple the anode terminal to the anode rail and the cathode terminal to the cathode rail respectively.

6. The battery cell of claim 1 wherein the first and the third interlocking features are adapted to mechanically interfere with the second and the fourth interlocking features respectively to maintain mechanical and electrical coupling of the anode terminal and the cathode terminal with the anode rail and the cathode rail respectively.

7. The battery cell of claim 1 wherein:
the first interlocking feature comprises a protrusion;
the second interlocking feature comprises a groove;
the protrusion engages the groove slidably; and
an inner surface of the groove interferes with an outer surface of the protrusion to maintain engagement of the protrusion with the groove.

8. The battery cell of claim 1 wherein:
the first interlocking feature comprises a groove;
the second interlocking feature comprises a protrusion;
the protrusion engages the groove slidably; and
an inner surface of the groove interferes with an outer surface of the protrusion to maintain engagement of the protrusion with the groove.

9. A battery pack comprising:
a plurality of battery cells, each battery cell includes an anode terminal, a cathode terminal and a container, the container has a first width, the anode terminal and the cathode terminal positioned to least partially on an outer surface of the container, each anode terminal includes a first interlocking feature, each cathode terminal includes a second interlocking feature;
an anode rail, the anode rail includes a third interlocking feature adapted to engage with the first interlocking feature of each anode terminal;
a cathode rail, the cathode rail includes a fourth interlocking feature adapted to engage with the second interlocking feature of each cathode terminal; wherein:
while engaged, the first interlocking feature of each anode terminal interferes with the third interlocking feature of the anode rail thereby mechanically coupling the anode terminal to the anode rail; and
while engaged, the second interlocking feature of each cathode terminal interferes with the fourth interlocking feature of the cathode rail thereby mechanically coupling the cathode terminal to the cathode rail.

10. The battery pack of claim 9 wherein:
the anode terminal has a second width;
the cathode terminal has a third width; and
at least one of the second width in the third width is at least 70 percent of the first width.

11. The battery pack of claim 9 wherein:
the anode terminal has a second width;
the cathode terminal has a third width; and
at least one of the second width in the third width is at most 30 percent of the first width.

12. The battery pack of claim 9 wherein while the first interlocking feature of each anode terminal is engaged with the third interlocking feature of the anode rail, the anode terminal electrically couples to the anode rail.

13. The battery pack of claim 9 wherein while the second interlocking feature of each cathode terminal is engaged with the fourth interlocking feature of the cathode rail, the cathode terminal electrically couples to the cathode rail.

14. The battery pack of claim 9 wherein engaging the first interlocking feature of each anode terminal to the third interlocking feature of the anode rail and the second interlocking feature of each cathode terminal to the fourth interlocking feature of the cathode rail physically positions the plurality of battery cells with respect to each other.

15. The battery pack of claim 9 wherein:
the first interlocking feature comprises a protrusion;
the second interlocking feature comprises a groove;
the protrusion engages the groove slidably; and
an inner surface of the groove interferes with an outer surface of the protrusion to maintain engagement of the protrusion with the groove.

16. The battery pack of claim 9 wherein:
the first interlocking feature comprises a groove;
the second interlocking feature comprises a protrusion;
the protrusion engages the groove slidably; and
an inner surface of the groove interferes with an outer surface of the protrusion to maintain engagement of the protrusion with the groove.

17. A battery cell comprising:
a plurality of anode electrodes;
a plurality of cathode electrodes;
a container having a first width and a first length, wherein the plurality of anode electrodes and the plurality of cathode electrodes are positioned in the container;
an anode terminal having a second width and a second length, wherein the second width and the second length is at least 90% of the first width and the first length respectively, wherein the anode terminal is positioned at least partially on an exterior of the container, wherein each anode electrode of the plurality of anode electrodes mechanically and electrically couples to the anode terminal, wherein the anode terminal includes a first interlocking feature adapted to slidingly engage with a second interlocking feature of an anode rail of a battery pack to mechanically and electrically couple the anode terminal to the anode rail; and
a cathode terminal having a third width and a third length, wherein the third width and the third length is at least 90% of the first width and the first length respectively, wherein the cathode terminal is positioned at least partially on the exterior of the container, wherein each cathode electrode of the plurality of cathode electrodes mechanically and electrically couples to the cathode terminal, wherein the cathode terminal includes a third interlocking feature adapted to slidingly engage with a fourth interlocking feature of an cathode rail of the battery pack to mechanically and electrically couple the cathode terminal to the cathode rail.

18. The battery cell of claim 17 further comprising a gasket positioned around the anode terminal, wherein the gasket electrically insulates the container from the anode terminal.

19. The battery cell of claim 18 further comprising a steel ring positioned around the anode terminal and against the gasket, wherein the steel ring retains the gasket in position around the anode terminal.

20. The battery cell of claim 17 further comprising a plate, wherein the plate mechanically and electrically couples to an inner surface of the anode terminal and each anode electrode of the plurality of anode electrodes mechanically and electrically couples to the anode terminal through the plate.
